(19) United States
(12) Patent Application Publication
(10) Pub. No.: US 2004/0193435 A1
(43) Pub. Date: Sep. 30, 2004

(54) EDI declaration management system and method

(76) Inventor: Xuemin Fang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/654,110

(22) Filed: Sep. 2, 2003

(30) Foreign Application Priority Data
Mar. 28, 2003 (TW) 92107190

(51) Int. Cl. G06F 17/60

(52) U.S. Cl. 705/1

(57) ABSTRACT

An EDI (Electronic Data Interchange) declaration management system includes a local database (16), an EDI declaration server (12), a customs server (18) and a customs database (20). The EDI declaration server includes a customs declaration generating module (121) for setting parameters for customs declarations, and generating different customs declarations according to customs declaration types; a document format transforming module (122) for transforming the customs declarations into standard EDI documents, and transforming customs return receipts transmitted from the customs server in EDI format into human-readable documents; an EDI document transmitting module (123) for transmitting the standard EDI documents to the customs server via a communications network; a customs return receipt receiving module (124) for receiving the customs return receipts, and updating corresponding parameters for the customs declarations according to the customs return receipts. An EDI declaration management method is also disclosed.

### BACKGROUND OF THE INVENTION

1. Field of the Invention

The present invention relates to customs declaration management systems and methods, and especially to an electronic customs declaration management system and method that can transmit data via an EDI (electronic data interchange) communications network.

2. Background of the Invention

Traditionally, most procedures for customs clearance of transported merchandise are handled manually. Manual operations are mostly time-consuming and inefficient. Moreover, conventional customs clearance methods require processing of huge contracts, each of which has a register manual. To process the contracts not only retards management efficiency, but also disadvantages declaration activities.

With the development of information technology and network technology, electronic declaration means have become more and more popular for customs clearance. Declaring enterprises can apply to customs online through a communications network. Customs officers can also audit declaration documents online, and send processing results such as customs return receipts to the declaring enterprises via the communications network. Electronic declaration can simplify declaration procedures, reduce processing times, and improve declaration efficiency.

At present, customs declaration management systems mostly utilize EDI (Electronic Data Interchange) means. Main functions of a typical EDI declaration management system include setting EDI parameters, managing declaration documents, and managing document transmission and receipt. The EDI declaration management system can generate declaration documents according to declaration data provided by a declaring enterprise's internal information system or data input by users of the enterprise, transform formats of the declaration documents, and transmit the formatted declaration documents to customs. The users of the declaring enterprise update the corresponding declaration parameters, and store the updated results in a local database after receiving customs return receipts. The customs declarations may include ordinary customs declarations and accumulative customs declarations. However, at present, no system provides means for handling customs declarations differently according to their respective types. Similarly, there are no means for setting corresponding parameters in the customs declarations according to their respective types. The efficiency with which customs declarations are handled is in need of improvement.

### SUMMARY OF THE INVENTION

A main objective of the present invention is to provide an electronic customs declaration management system and method transmitting data via an EDI communications network, in which customs declarations can be conveniently dealt with according to their types, and in which customs declaration parameters can be set according to the customs declaration types.

To accomplish the above objective, an EDI declaration management system in accordance with a preferred embodiment of the present invention comprises an EDI declaration server, a local database linking to the EDI declaration server through a connection, a customs server, and a customs database linking to the customs server. The EDI declaration server comprises a customs declaration generating module for setting customs declaration parameters, and generating different customs declarations according to the customs declaration types; a document format transforming module for transforming the customs declarations into standard EDI documents, and transforming customs return receipts transmitted from the customs server in EDI format into human-readable documents; an EDI document transmitting module for transmitting the standard EDI documents to the customs server via a communications network; a customs return receipt receiving module for receiving the customs return receipts, and updating corresponding parameters of the customs declarations stored in the local database according to the customs return receipts; and a customs declaration status inquiring module for providing a function of inquiring of statuses of the customs declarations.

The customs declaration generating module comprises a customs declaration parameter setting sub-module for setting initial parameter values for the customs declarations according to their respective customs declaration types; an ordinary customs declaration maintaining sub-module for generating ordinary customs declarations as well as providing functions of modifying, deleting, searching, and printing the ordinary customs declarations; an accumulative customs declaration maintaining sub-module for generating accumulative customs declarations as well as providing functions of modifying, deleting, searching, and printing the accumulative customs declarations; a serial number generating sub-module for generating serial numbers for the ordinary customs declarations and the accumulative customs declarations; and a monthly declaration report generating sub-module for generating a monthly declaration report each month.

Further, the present invention provides an EDI declaration management method, which comprises the steps of: (1) receiving declaration data; (2) generating a customs declaration according to the declaration data; (3) transforming the customs declaration into a standard EDI document; (4) transmitting the standard EDI document to a customs server; (5) transforming the standard EDI document into a human-readable declaration document; (6) generating a customs return receipt according to the declaration document; and (7) processing the customs return receipt, and storing updated results in a local database.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a schematic diagram of hardware configuration of an EDI (Electronic Data Interchange) declaration management system in accordance with the preferred embodiment of the present invention;

FIG. 2 is a schematic diagram of main function modules of an EDI declaration server of the system of FIG. 1;

FIG. 3 is a schematic diagram of main sub-modules of a customs declaration generating module of the EDI declaration server of FIG. 2;

FIG. 4 is a flowchart of a preferred method for implementing the EDI declaration management system of the present invention; and

FIG. 5 is a flowchart of a preferred method for generating customs declarations in accordance with the present invention.

### DETAILED DESCRIPTION OF THE INVENTION

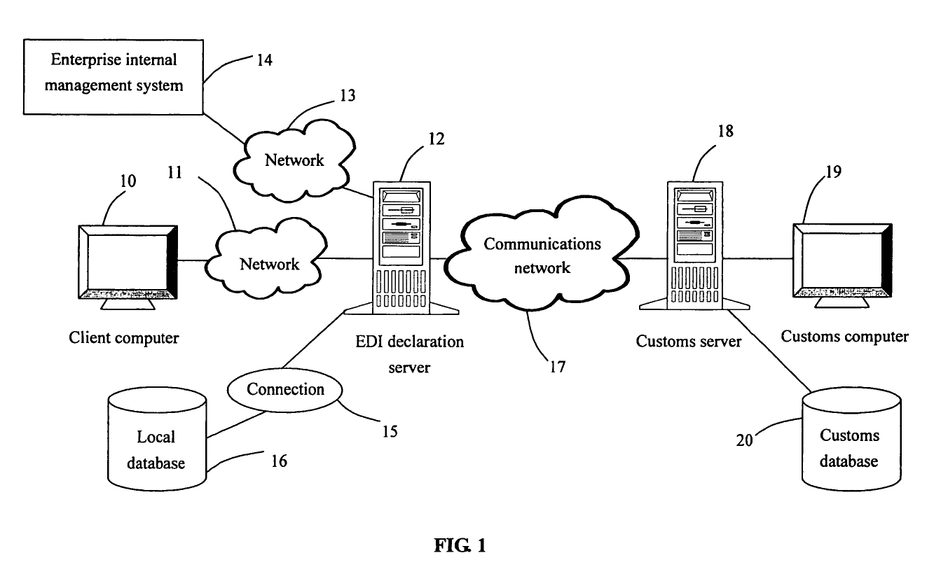

FIG. 1 is a schematic diagram of hardware configuration of an EDI (Electronic Data Interchange) declaration management system in accordance with the preferred embodiment of the present invention. The system comprises a plurality of client computers 10 (only one shown), an EDI declaration server 12, an enterprise internal management system 14, a local database 16, a customs server 18, a plurality of customs computers 19 (only one shown), and a customs database 20. Each client computer 10 provides an interactive user interface for users of a declaring enterprise to perform declaration operations. The EDI declaration server 12 is used for generating customs declarations, transforming the customs declarations into standard EDI documents, transmitting the standard EDI documents to a customs authority (hereinafter, “customs”), receiving customs return receipts, and inquiring of statuses of the customs declarations. The enterprise internal management system 14 provides corresponding declaration information for the EDI declaration server 12 to generate customs declarations. The local database 16 is used for storing customs declarations and other basic data used or generated by the EDI declaration server 12. The customs server 18 is used for receiving standard EDI documents from the EDI declaration server 12, transforming the standard EDI documents into human-readable documents, generating customs return receipts, and transmitting the customs return receipts to the EDI declaration server 12. A human-readable document means a document in a form that typically is easily read by people. The customs database 20 is used for storing data used or generated in the customs server 18, including customs return receipts and standard EDI documents transmitted from the EDI declaration server 12. Each customs computer 19 provides a user interface for customs officers to perform declaration operations.

The client computers 10 are connected to the EDI declaration server 12 through a network 11. The EDI declaration server 12 is connected to the enterprise internal management system 14 through a network 13. The network 11 and the network 13 may be an intranet, the Internet or any other suitable type of communications network. The EDI declaration server 12 is connected to the local database 16 through a connection 15, which is database connectivity such as Open Database Connectivity (ODBC) or Java Database Connectivity (JDBC). Further, the EDI declaration server 12 communicates with the customs server 18 via a communications network 17. The communications network 17 may be a Value Added Network (VAN) or another suitable type of communications link.

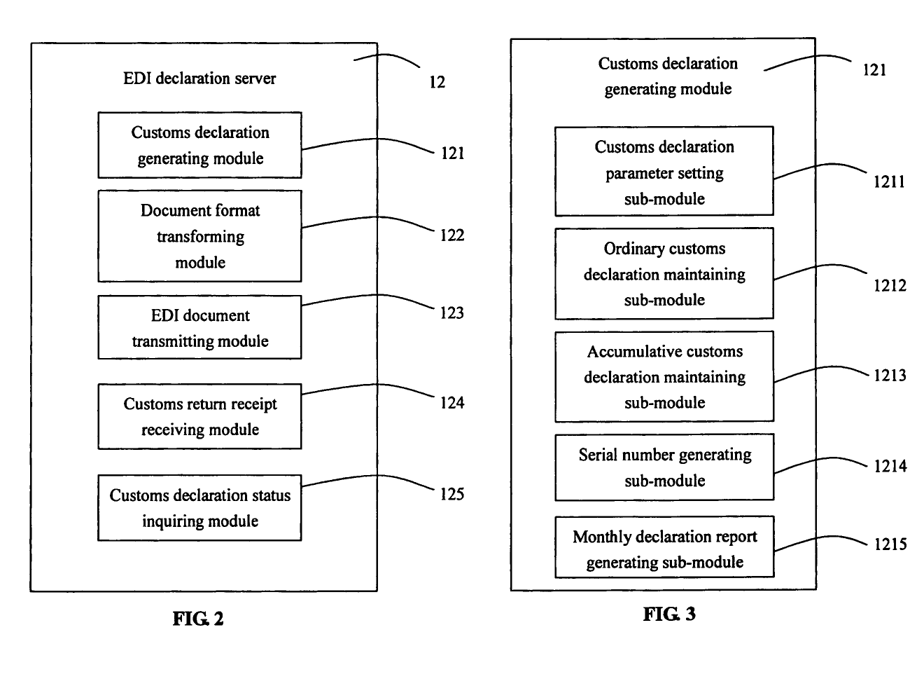

FIG. 2 is a schematic diagram of main function modules of the EDI declaration server 12. The EDI declaration server 12 comprises a customs declaration generating module 121, a document format transforming module 122, an EDI document transmitting module 123, a customs return receipt receiving module 124, and a customs declaration status inquiring module 125.

The customs declaration generating module 121 is used for determining customs declaration types according to information provided by the enterprise internal management system 14 or information input by users of the declaring enterprise through any of the client computers 10, setting parameters for the customs declarations, and generating different customs declarations according to the customs declaration types. The information that can be provided by the enterprise internal management system 14 may include merchandise types, amounts, gross weights, net weights, transportation means, etc. The customs declaration types may include an ordinary customs declaration and an accumulative customs declaration. When an accumulative customs declaration is used, the declaring enterprise need not transmit a customs declaration to customs on each occasion when merchandise is transported. Instead, the declaring enterprise transmits to customs the accumulative customs declaration, which is generated by accumulating customs declarations within a fixed period determined by the declaring enterprise. The fixed period may for example be a calendar week, or may be another time period as determined by the declaring enterprise. The document format transforming module 122 is used for transforming the customs declarations into standard EDI documents, or transforming customs return receipts transmitted from the customs server 18 in EDI format into human-readable documents. The EDI document transmitting module 123 is used for transmitting the standard EDI documents to the customs server 18 via the communications network 17. The customs return receipt receiving module 124 receives the customs return receipts, and updates corresponding parameters for the customs declarations stored in the local database 16 according to the customs return receipts. The customs declaration status inquiring module 125 provides a function of inquiring of statuses of the customs declarations.

FIG. 3 is a schematic diagram of main sub-modules of the customs declaration generating module 121. The customs declaration generating module 121 comprises a customs declaration parameter setting sub-module 1211, an ordinary customs declaration maintaining sub-module 1212, an accumulative customs declaration maintaining sub-module 1213, a serial number generating sub-module 1214, and a monthly declaration report generating sub-module 1215.

The customs declaration parameter setting sub-module 1211 is used for setting initial parameter values for customs declarations according to their respective customs declaration types. The parameters for each customs declaration may include a customs declaration type, a customs serial number, a declaration date, transportation means, a declaring enterprise name, etc. The ordinary customs declaration maintaining sub-module 1212 is used for generating ordinary customs declarations as well as providing functions such as modifying, deleting, searching, and printing the ordinary customs declarations. The accumulative customs declaration maintaining sub-module 1213 is used for generating accumulative customs declarations as well as providing functions such as modifying, deleting, searching, and printing the accumulative customs declarations. The serial number generating sub-module 1214 is used for generating serial numbers for the ordinary customs declarations and the accumulative customs declarations. The monthly declaration report generating sub-module 1215 is used for generating a monthly declaration report at the end of each month.

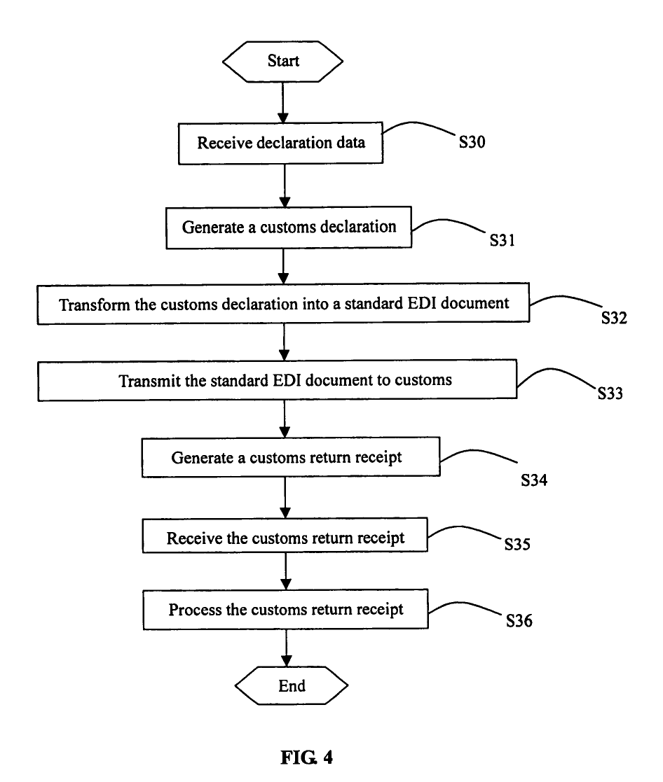

FIG. 4 is a flowchart of a preferred method for implementing the EDI declaration management system of the present invention. In step S30, the EDI declaration server 12 receives declaration data directly from the enterprise internal management system 14, or declaration data input by operators of the declaring enterprise through any of the client computers 10. In step S31, the customs declaration generating module 121 automatically generates a customs declaration according to the declaration data. The customs declaration may be an ordinary customs declaration or an accumulative customs declaration. In step S32, the document format transforming module 122 transforms the customs declaration into a standard EDI document. In step S33, the EDI document transmitting module 123 transmits the standard EDI document to the customs server 18 through the communications network 17. In step S34, the customs server 18 transforms the standard EDI document into a human-readable declaration document, and stores the declaration document in the customs database 20. Customs officers reply to the declaration document. A customs return receipt is then generated according to the declaration document. The customs return receipt is transmitted to the EDI declaration server 12 through the communications network 17 after being transformed into a standard EDI document. In step S35, the EDI declaration server 12 receives the customs return receipt in EDI format, transforms the customs return receipt into a human-readable document, and stores the human-readable document in the local database 16. In step S36, operators of the declaring enterprise process the customs return receipt through any of the client computers 10. The EDI declaration server 12 receives the processing results, updates the corresponding parameters for the customs declaration, and stores the updated results in the local database 16.

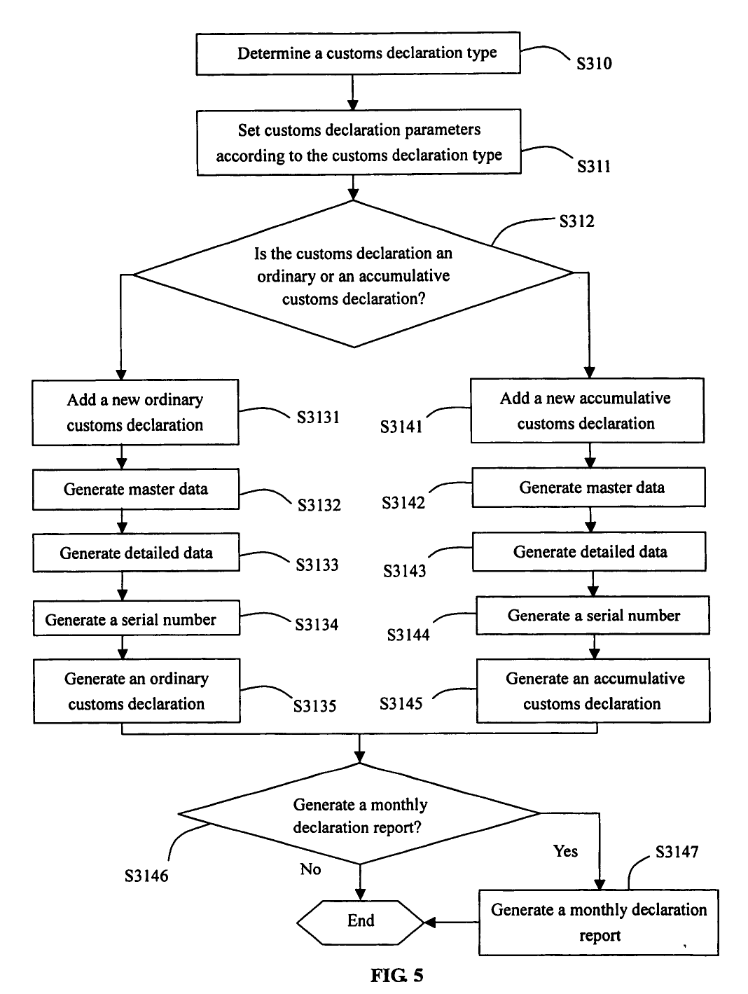

FIG. 5 is a flowchart of a preferred method for generating a customs declaration in accordance with the present invention, said method being comprised in step S31 of FIG. 4. In step S310, the customs declaration generating module 121 receives declaration data, and determines a customs declaration type according to the declaration data. The customs declaration type may be an ordinary customs declaration or an accumulative customs declaration. In step S311, users of the declaring enterprise set parameters for the customs declaration according to the determined customs declaration type through the customs declaration parameter setting sub-module 1211. In step S312, the customs declaration generating module 121 determines whether the customs declaration is an ordinary customs declaration or an accumulative customs declaration. If the customs declaration is an accumulative customs declaration, the procedure goes directly to step S3141 described below.

If the customs declaration is an ordinary customs declaration, in step S3131, the users of the declaring enterprise add a new ordinary customs declaration through one of the client computers 10. In step S3132, the ordinary customs declaration maintaining sub-module 1212 generates master data according to the declaration data. The master data may include a filed number, a declaration date, a declaring enterprise name, a transportation means, etc. In step S3133, the ordinary customs declaration maintaining sub-module 1212 generates detailed data in accordance with the declaration data. The detailed data may include product numbers, product names, product specifications, etc. In step S3134, the serial number generating sub-module 1214 automatically generates a serial number according to the master data, the detailed data and historical serial numbers, and stores the serial number in the local database 16. In step S3135, the ordinary customs declaration maintaining sub-module 1212 automatically generates an ordinary customs declaration according to the master data, the detailed data and the serial number, and stores the ordinary customs declaration in the local database 16. The procedure then goes to step S3146 described below.

In step S3141, the users of the declaring enterprise add a new accumulative customs declaration through one of the client computers 10. In step S3142, the accumulative customs declaration maintaining sub-module 1213 generates master data according to the declaration data. In step S3143, the accumulative customs declaration maintaining sub-module 1213 generates detailed data in accordance with the declaration data. In step S3144, the serial number generating sub-module 1214 automatically generates a serial number according to the master data, the detailed data and historical serial numbers, and stores the serial number in the local database 16. In step S3145, the accumulative customs declaration maintaining sub-module 1213 automatically generates an accumulative customs declaration according to the master data, the detailed data and the serial number, and stores the accumulative customs declaration in the local database 16. The procedure then goes to step S3146 described below.

In step S3146, the monthly declaration report generating sub-module 1215 determines whether there is need to generate a monthly declaration report. If there is no need to generate a monthly declaration report, the procedure is ended. If there is a need to generate a monthly declaration report, in step S3147, the monthly declaration report generating sub-module 1215 automatically generates a monthly declaration report according to the ordinary customs declarations and accumulative customs declarations of the relevant month stored in the local database 16. Thereupon, the procedure is ended.

Although the present invention has been specifically described on the basis of a preferred embodiment and preferred methods, the invention is not to be construed as being limited thereto. Various changes or modifications may be made to said embodiment and methods without departing from the scope and spirit of the invention.

What is claimed is:

1. An EDI (Electronic Data Interchange) declaration management system comprising an EDI declaration server, a local database linking to the EDI declaration server through a connection, a customs server, and a customs database linking to the customs server, wherein the EDI declaration server comprises:
a customs declaration generating module for setting parameters for customs declarations, and generating different customs declarations according to customs declaration types;
a document format transforming module for transforming the customs declarations into standard EDI documents, and transforming customs return receipts transmitted from the customs server in EDI format into human-readable documents;
an EDI document transmitting module for transmitting the standard EDI documents to the customs server via a communications network; and
a customs return receipt receiving module for receiving the customs return receipts, and updating corresponding parameters for the customs declarations stored in the local database according to the customs return receipts.

2. The system according to claim 1, wherein the EDI declaration server further comprises a customs declaration status inquiring module for providing a function of inquiring of statuses of the customs declarations.

3. The system according to claim 1, further comprising an enterprise internal management system for providing corresponding declaration information for the EDI declaration server to generate customs declarations.

4. The system according to claim 1, wherein the customs declaration generating module comprises a customs declaration parameter setting sub-module for setting initial parameter values for customs declarations according to their respective customs declaration types.

5. The system according to claim 1, wherein the customs declaration generating module further comprises an ordinary customs declaration maintaining sub-module, for generating ordinary customs declarations as well as providing functions of modifying, deleting, searching, and printing the ordinary customs declarations.

6. The system according to claim 1, wherein the customs declaration generating module further comprises an accumulative customs declaration maintaining sub-module, for generating accumulative customs declarations as well as providing functions of modifying, deleting, searching, and printing the accumulative customs declarations.

7. The system according to claim 1, wherein the customs declaration generating module further comprises a serial number generating sub-module for generating serial numbers for the ordinary customs declarations and the accumulative customs declarations.

8. The system according to claim 1, wherein the customs declaration generating module further comprises a monthly declaration report generating sub-module for generating a monthly declaration report each month.

9. The system according to claim 1, wherein the EDI declaration server may communicate with the customs server via a communications network.

10. A computer-implemented EDI (Electronic Data Interchange) declaration management method, comprising the steps of:
(a) receiving declaration data;
(b) generating a customs declaration according to the declaration data;
(c) transforming the customs declaration into a standard EDI document;
(d) transmitting the standard EDI document to a customs server;
(e) transforming the standard EDI document into a human-readable declaration document;
(f) generating a customs return receipt according to the declaration document; and
(g) processing the customs return receipt, and storing updated results in a local database.

11. The method according to claim 10, wherein step (b) comprises the step of determining a customs declaration type.

12. The method according to claim 11, wherein step (b) comprises the step of setting customs declaration parameters according to the customs declaration type.

13. The method according to claim 10, wherein step (b) comprises generating an ordinary customs declaration or generating an accumulative customs declaration.

14. The method according to claim 13, wherein generating an ordinary customs declaration comprises:
adding a new ordinary customs declaration;
generating master data;
generating detailed data; and
generating a serial number.

15. The method according to claim 13, wherein generating an accumulative customs declaration comprises:
adding a new accumulative customs declaration;
generating master data;
generating detailed data; and
generating a serial number.

16. The method according to claim 10, further comprising the step of generating a monthly declaration report.

17. A computer-implemented EDI (Electronic Data Interchange) declaration management method, comprising the steps of:
(a) receiving declaration data;
(b) generating a customs declaration according to the declaration data and desired customs declaration types including an ordinary customs declaration and an accumulative customs declaration;
(c) transforming the customs declaration into a standard EDI document;
(d) transmitting the standard EDI document to a customs server;
(e) generating a customs return receipt; and
(f) processing the customs return receipt, and updating results.
